(19) United States
(12) Patent Application Publication
(10) Pub. No.: US 2022/0168678 A1
(43) Pub. Date: Jun. 2, 2022

(54) PORTABLE AIR PURIFIER

(71) Applicant: Tien-Tse Hsieh, Tainan City (TW)

(72) Inventor: Tien-Tse Hsieh, Tainan City (TW)

(21) Appl. No.: 17/534,573

(22) Filed: Nov. 24, 2021

Related U.S. Application Data
(60) Provisional application No. 63/119,010, filed on Nov. 30, 2020.

(51) Int. Cl. B01D 46/00; B01D 46/24; B01D 46/42; A62B 7/10; A62B 9/02

(52) U.S. Cl. CPC B01D 46/0005; B01D 46/2403; B01D 46/0049; B01D 46/4272; B01D 46/0032; A62B 9/02; B01D 2265/029; B01D 2273/30; B01D 46/0036; A62B 7/10

(57) ABSTRACT

A portable air purifier includes an air purification module and a housing. The housing is connected to the air purification module. The housing has a first air supply port and a nozzle portion. The nozzle portion has a second air supply port. When in use, the air purified by the air purification module is guided out from the first air supply port or/and the second air supply port, so that a user can choose different air supply modes as desired.

### CROSS-REFERENCE TO RELATED APPLICATION

This application claims the benefit of U.S. Provisional Application No. 63/119,010, filed on Nov. 30, 2020. The above identified patent application is herein incorporated by reference in its entirety to provide continuity of disclosure.

### FIELD OF THE INVENTION

The present invention relates to an air purifier, and more particularly to a portable air purifier.

### BACKGROUND OF THE INVENTION

The problem of air pollution is getting increasingly worse. Many people wear face masks or use air purifiers to avoid inhaling hazardous substances in the air.

However, wearing a face mask is uncomfortable. The user may feel hot or stuffy. Therefore, face masks are not suitable for users who engage in outdoor sports, leisure activities, or those who have sensitive skin. Air purifiers are only suitable for relatively small spaces, such as car's interiors or indoor spaces.

In addition, the airtightness of face masks may be different depending on the types of masks. Specifically, the mask which is comfortable to wear has poor airtight, and the mask having good airtightness may be uncomfortable when wearing it.

### SUMMARY OF THE INVENTION

The present invention is to provide a portable air purifier, comprising an air purification module, a housing, and a switching module. The housing is configured to accommodate the air purification module. The housing has a first air supply port and a nozzle portion. The nozzle portion has a second air supply port. The second air supply port is adjacent to the first air supply port. The nozzle portion extends upwardly beyond the first air supply port. The second air supply port is relatively smaller than the first air supply port. The switching module is connected to the housing and configured to guide air purified by the air purification module to the first air supply port or the second air supply port.

Preferably, the switching module includes a movable cover. The movable cover is movably disposed adjacent to the first air supply port.

Preferably, the housing has a guide part adjacent to the first air supply port. At least one part of the guide part is disposed outside the first air supply port for at least one part of the movable cover to be moved in the guide part to an open position for opening the first air supply port.

Preferably, the guide part is a guide channel. The movable cover is in the form of a flexible sheet having a plurality of spaced dents thereon. The movable cover is bendable and deformable to be received in an axial section of the guide channel.

Preferably, the movable cover has a pull portion. The pull portion is located at the first air supply port.

Preferably, the air purification module includes a filter element and a fan. Both the filter element and the fan are disposed in an airflow passage of the housing. The filter element has a hollow cylindrical body. The filter element has a guide end and an outlet end opposite to the guide end. The hollow cylindrical body of the filter element has a plurality of filter parts arranged annularly. The guide end faces and communicates with an air inlet of the airflow passage, so that air is guided to the filter parts for filtering and then flows through the outlet end to the first air supply port and/or the second air supply port.

Preferably, the filter element includes a filter body and a retaining seat. The filter body is a cylindrical body having two open ends. The filter parts are disposed on the filter body. The retaining seat is connected to the housing. The retaining seat is hollow and has the guide end and the outlet end at two opposite ends thereof. The retaining seat has a plurality of grooves arranged annularly between the guide end and the outlet end. The retaining seat is inserted in the filter body. The grooves correspond to the filter parts, respectively.

Preferably, the housing includes a first housing and a second housing. The first housing is detachably connected in series to the second housing. The filter body is located in the first housing. The retaining seat is installed in the second housing.

Preferably, the outlet end of the retaining seat and the second housing have corresponding screw threads for the outlet end of the retaining seat to be locked to the second housing. The guide end of the retaining seat extends out of the filter element. The retaining seat and the filter element are detachable from the second housing by rotating the guide end.

Preferably, the nozzle portion is detachable.

Preferably, the nozzle portion includes a protective layer made of a soft material and a nozzle housing made of a hard material. The nozzle housing is covered with the protective layer. Through the protective layer, the nozzle portion is tightly connected to a nozzle mounting hole of the housing.

Preferably, the housing defines an air inlet, an airflow passage and the first air supply port that communicate with each other along an axis. The second air supply port of the nozzle housing is deviated from the axis.

Preferably, the nozzle portion is provided with a backflow preventer corresponding in position to the second air supply port.

Preferably, the backflow preventer is in the form of a check valve.

Preferably, the first air supply port is located adjacent to a first side of the housing, and the second air supply port is located adjacent to a second side of the housing. The first air supply port is inclined toward the first side of the housing. The air inlet is inclined toward the second side of the housing.

With the above features, the present invention can achieve the following effects:

1. The housing of the air purifier has the first air supply port and the protruding nozzle portion. It is convenient for the user to choose different air supply modes (usage modes) as desired, so as to meet the needs of the user in different situations. Compared with the high airtightness of face masks, the portable air purifier provided by the present invention takes into account the requirements of comfort and purifying air.

2. The second air supply port of the nozzle portion is relatively smaller than the first air supply port to concentrate the purified air for the user to inhale the purified air through the mouth conveniently. The first air supply port enables the purified air to spread from the first air supply port to the user's surrounding.

3. The nozzle portion is detachable to facilitate the removal of the nozzle portion for cleaning or replacement.

4. The air supply modes can be switched by the switching module so that the purified air can be directed to the first air supply port or the second air supply port only, so as to reduce the dispersion of the airflow.

5. With the cylindrical filter element and the diversion design, the air inflow and the filter area can be increased, and the service life of the filter element can be prolonged.

### BRIEF DESCRIPTION OF THE DRAWINGS

FIG. 1 is a perspective view according to an embodiment of the present invention;

FIG. 2 is a schematic view according to an embodiment of the present invention when in use;

FIG. 3 is an exploded view according to an embodiment of the present invention;

FIG. 4 is a cross-sectional view according to an embodiment of the present invention when in use, illustrating that a movable cover is in an open position;

FIG. 5 is a cross-sectional view according to an embodiment of the present invention when in use, illustrating that the movable cover is in a closed position;

FIG. 6 is a schematic view according to an embodiment of the present invention when in use, illustrating that the purified air is guided out from a first air supply port;

FIG. 7 is a schematic view according to an embodiment of the present invention when in use, illustrating that the purified air is guided out from a second air supply port;

FIG. 8 is an exploded view of a nozzle portion according to an embodiment of the present invention;

FIG. 9A is a schematic view according to an embodiment of the present invention, illustrating that a first housing is detached from a second housing; and

FIG. 9B is a schematic view according to an embodiment of the present invention, illustrating that the first housing is removed.

### DETAILED DESCRIPTION OF THE PREFERRED EMBODIMENTS

Embodiments of the present invention will now be described, by way of example only, with reference to the accompanying drawings. It will be understood that, although the terms “first,” “second,” etc., may be used herein to describe various elements/parts, these elements/parts should not be limited by these terms. These terms are used to distinguish one element/part from another element/part. Thus, a first element/part described below could be termed a second element/part, without departing from the spirit and scope of the present invention. Spatially relative terms, such as “upper,” “lower,” “left,” “right,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

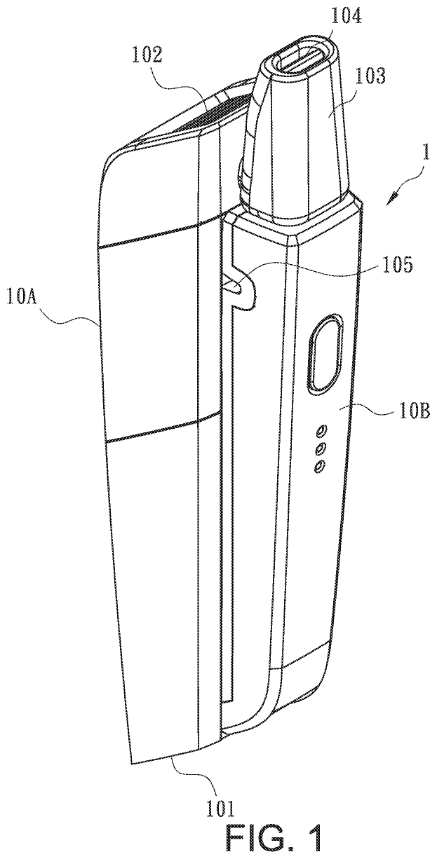

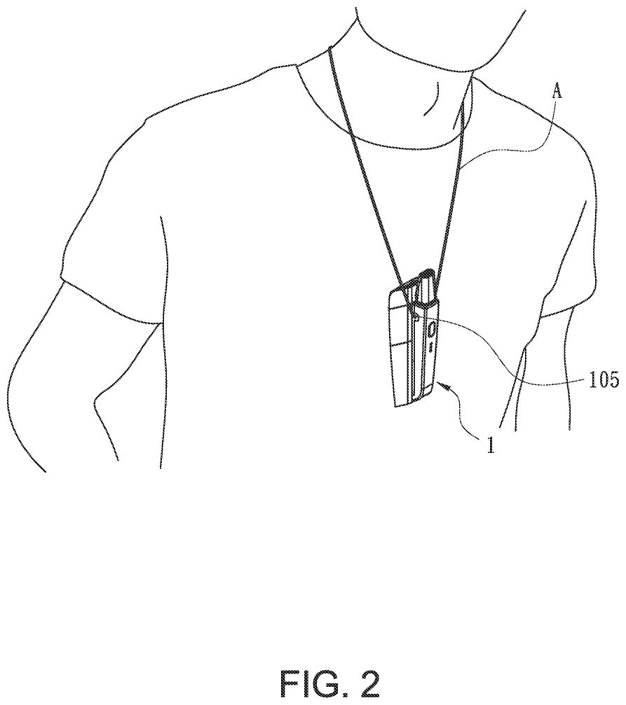

Referring to FIG. 1 and FIG. 2, a portable air purifier according to an embodiment of the present invention comprises a housing (1). The housing (1) may be made of a plastic, wood, metal (such as aluminum alloy or titanium alloy), composite material, etc. The housing (1) has an air inlet (101) and a first air supply port (102) at two ends of the housing (1), respectively. The housing (1) further has a nozzle portion (103). The nozzle portion (103) extends upwardly beyond the first air supply port (102). The nozzle portion (103) has a second air supply port (104). The second air supply port (104) may be located adjacent to the first air supply port (102). The second air supply port (104) may be relatively smaller than the first air supply port (102). In addition, the housing (1) may be formed with a perforation (105) for a neck strap (A) to pass through the perforation (105), so that the user may wear the portable air purifier for use. Specifically, the first air supply port (102) is located adjacent to a first side (10A) of the housing (1), and the second air supply port (104) is located adjacent to a second side (10B) of the housing (1). The first air supply port (102) is inclined toward the first side (10A) of the housing (1), and the air inlet (101) is inclined toward the second side (10B) of the housing (1). When in use, the user wears the portable air purifier for the first air supply port (102) to supply purified air to the user. The air inlet (101) may be arranged to face the outside for introducing external air into the portable air purifier. This prevents the air supply port (102) from being blocked by clothing and other objects on the user's body

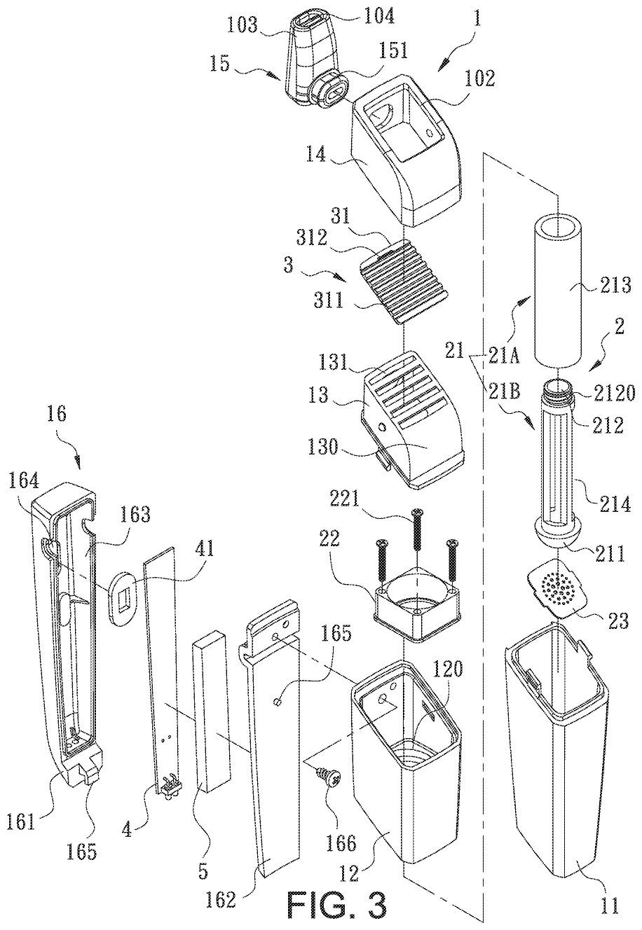

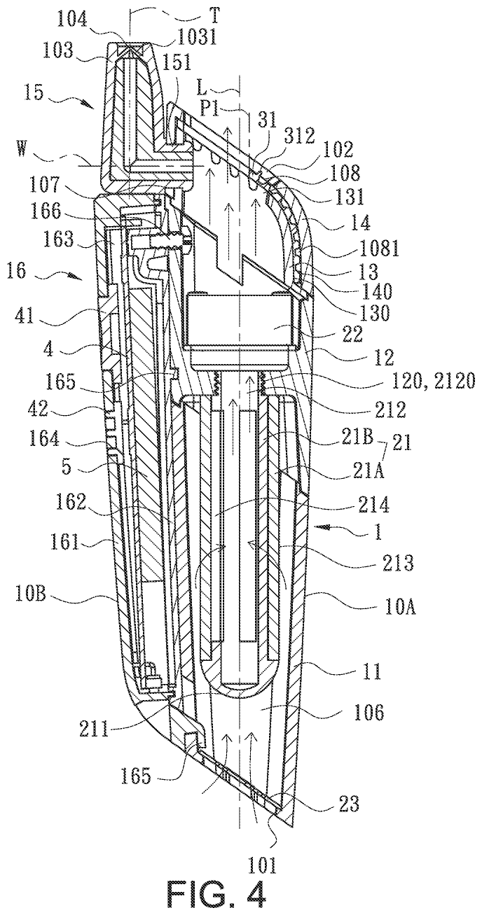

Referring to FIG. 3 and FIG. 4, the housing (1) is configured to accommodate an air purification module (2), a switching module (3), a control module (4), and a power supply module (5). The housing (1) may include a plurality of housings of the same material or different materials, so as to facilitate production and assembly. Specifically, in this embodiment, the housing (1) includes a first housing (11), a second housing (12), a third housing (13), a fourth housing (14), a nozzle housing (15), and a protective housing (16). The first housing (11), the second housing (12), the third housing (13), and the fourth housing (14) are connected in series along an axis (L) by a snap-fit connection, by bonding, and so on, such that an airflow passage (106) is defined in the housing (1) to communicate with the air inlet (101) and the first air supply port (102). The third housing (13) and the fourth housing (14) are connected with each other. (For example, they are connected and positioned through a concave-convex engaging structure). The first air supply port (102) is defined in the fourth housing (14). The third housing (13) has a plurality of spaced diversion holes (131) adjacent to the first air supply port (102) for dispersing and guiding the purified air to the first air supply port (102).

The nozzle housing (15) has the nozzle portion (103) and a connection portion (151). The nozzle portion (103) extends along a longitudinal direction (T). The longitudinal direction (T) is substantially parallel to the axis (L). The connection portion (151) extends along a width direction (W) that is substantially perpendicular to the longitudinal direction (T). The connection portion (151) is detachably connected to the fourth housing (14) adjacent to the first air supply port (102). For example, the connection portion (151) is insertedly connected to a nozzle mounting hole (107) jointly defined by the third housing (13) and the fourth housing (14).

The protective housing (16) is located adjacent to the nozzle housing (15). The protective housing (16) may include a first cover body (161) and a second cover body (162) to be assembled together. An accommodation room (163) is defined between the first cover body (161) and the second cover body (162) to accommodate the control module (4) and the power supply module (5) therein. The first cover body (161) may have a plurality of through holes (164) for receiving a control element (41) (such as a button) and a display lamp module (42) (such as LED lights, lampshades, and so on) of the control module (4), so that the user can operate and observe the portable air purifier. The second cover body (162) may be attached or locked to the first housing (11) and/or the second housing (12). For example, the first cover body (161) may have a plurality of engaging parts (165) to be first positioned, and then is locked by a screw (166). It should be understood that the first cover body (161) and the second cover body (162) may be further bonded by waterproof glue or other waterproof means to prevent moisture and other impurities from entering the protective housing (16) to damage the control module (4) and the power supply module (5), thereby enhancing the durability of the product.

The air purification module (2) may be selected from one of a physical filter module, an electrostatic adsorption filter module, an ultraviolet sterilization module, a photocatalyst module, an ozone module, a negative ion module, a fragrance module, and other module or a combination thereof, which is beneficial to improve air quality. In this embodiment, the air purification module (2) may include a filter element (21) and a fan (22). Both the filter element (21) and the fan (22) are disposed in the airflow passage (106) of the housing (1). The filter element (21) has a hollow cylindrical body, and has a guide end (211) and an outlet end (212) opposite to the guide end (211). The hollow cylindrical body of the filter element (21) has a plurality of filter parts (213) arranged annularly. The guide end (211) faces the air inlet (101) for guiding the air to the filter parts (213) to be filtered, and then the purified air flows through the outlet end (212) to the first air supply port (102) and/or the second air supply port (104). The fan (22) may be fixed to the second housing (12) by a plurality of coupling members (221) (such as screws), and is electrically connected to the control module (4). The fan (22) may be further equipped with rubber washers (not shown) or the like to prevent vibration and reduce noise. In addition, the air purification module (2) may further include a primary filter element (23). The primary filter element (23) is disposed adjacent to the air inlet (101) for primary filtering.

Specifically, the filter element (21) may further include a filter body (21A) and a retaining seat (21B). The filter body (21A) is a cylindrical body having two open ends. The filter parts (213) are disposed on the filter body (21A). The filter body (21A) may be an activated carbon filter, an electrostatic adsorption filter, a HEPA filter, and so on. The retaining seat (21B) is connected to the housing (1) and configured to support the filter body (21A). For example, one end of the retaining seat (21B) may be connected to the second housing (12) by locking, fitting, bonding, and so on. For example, the outlet end (212) of the retaining seat (21B) and the second housing (12) have corresponding screw threads (120, 2120) for the outlet end (212) of the retaining seat (21B) to be locked to the second housing (12). The retaining seat (21B) is hollow and has the guide end (211) and the outlet end (212) at two opposite ends. The retaining seat (21B) has a plurality of grooves (214) arranged annularly between the guide end (211) and the outlet end (212). The retaining seat (21B) is inserted in the filter body (21A). The grooves (214) correspond to the filter parts (213), respectively.

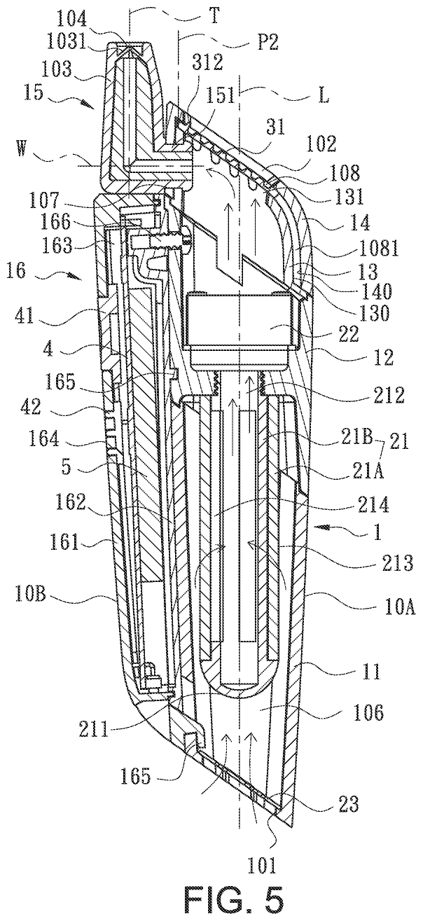

Referring to FIG. 4 and FIG. 5, the switching module (3) is configured to guide the air purified by the air purification module (2) to the first air supply port (102) or the second air supply port (104). In this embodiment, the switching module (3) may include a movable cover (31) which is movably disposed adjacent to the first air supply port (102). Preferably, the housing (1) may have a guide part adjacent to the first air supply port (102). For example, the guide part may be a guide channel (108) located between the third housing (13) and the fourth housing (14). At least one part of the guide part is disposed outside the first air supply port (102), so that at least one part of the movable cover (31) is moved out of the first air supply port (102) to an open position (P1) for opening the first air supply port (102). When the movable cover (31) is in the open position (P1), the second air supply port (104) has an airflow resistance greater than that of the first air supply port (102) because the second air supply port (104) is smaller than the first air supply port (102) and deviates from the axis (L). Therefore, the purified air will be directly guided to the first air supply port (102) along the axis (L). The movable cover (31) may be moved along the guide channel (108) to a closed position (P2) for closing the first air supply port (102). When the movable cover (31) is in the closed position (P2), the purified air will be guided to the second air supply port (104). Furthermore, in this embodiment, the movable cover (31) is moved in the guide channel (108) freely, so that it can be used to adjust the air supply flow of the first air supply port (102).

Preferably, the third housing (13) and the fourth housing (14) each have a curved surface (130, 140) adjacent to the first air supply port (102). The movable cover (31) may be in the form of a flexible sheet having a plurality of spaced dents (311) thereon. The movable cover (31) may be slightly bent and deformed to correspond to the surface (130, 140) and to be received in an axial section (1081) of the guide channel (108), so as to take advantage of the storage space. In addition, the movable cover (31) may have a pull portion (312). The pull portion (312) is located at the first air supply port (102) when the movable cover (31) is in the open position (P1) or the closed position (P2), such that the user can operate the movable cover (31) with ease.

It should be noted that the switching module (3) is not limited to the foregoing embodiment. For example, the switching module (3) may be in the form of a valve plate arranged in the airflow passage (106), or may be in the form of a shutter arranged at the first air supply port (102). The shutter can be turned and controlled to be opened and closed. The examples of the switching module (3) are all aimed for controlling the flow of the purified air. In addition, in this embodiment, the switching module (3) is operated manually, but it may be operated by other power sources, such as electric power.

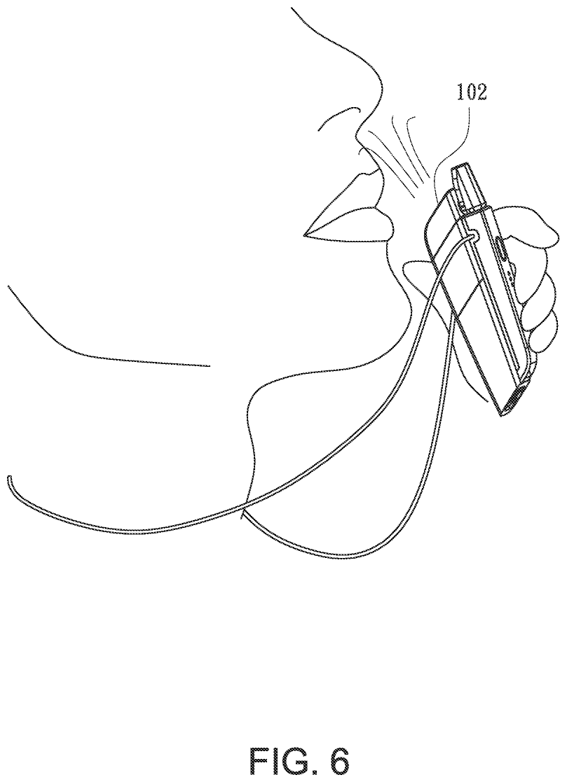

FIG. 4 and FIG. 6 illustrate a first usage mode according to the embodiment of the present invention. When in use, the user operates the pull portion (312) for the movable cover (31) to be slightly bent and deformed to slide into the axial section (1081) of the guide channel (108), so that the first air supply port (102) is opened, and the purified air is directly guided to the first air supply port (102) along the axis (L). The purified air is dispersed and guided to the first air supply port (102) through the diversion holes (131) of the third housing (13). Thus, the purified air spreads from the first air supply port (102) to the user's surrounding, so that the user can inhale the purified air through the mouth and nose. (The usage mode is shown in FIG. 1 and FIG. 6). However, the usage mode is not limited to this, and the portable air purifier may be used in a second usage mode described below. In the second usage mode, the user inhales the purified air only through the mouth.

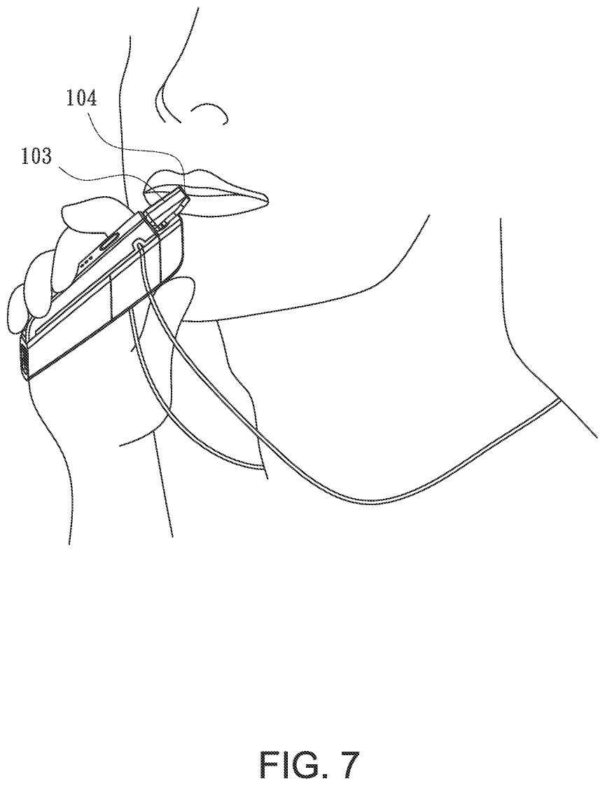

FIG. 5 and FIG. 7 illustrate a second usage mode according to the embodiment of the present invention. When in use, the user operates the pull portion (312) to move the movable cover (31) along the guide channel (108) to the closed position (P2) for the first air supply port (102) to be closed. When the movable cover (31) is in the closed position (P2), the purified air is directed to the second air supply port (104). Thus, the user can directly inhale the purified air from the nozzle portion (103) through the mouth. In addition, the nozzle portion (103) may be provided with a backflow preventer (1031) (such as a check valve) corresponding in position to the second air supply port (104), so as to prevent saliva and other substances from entering the interior of the portable air purifier along with backflowing air or blown-in air. When the air quality is poor, the user may use the portable air purifier in the second usage mode, allowing the user to inhale the purified air only. Furthermore, the purified air will not leak to the outside and can be fully used. (The user inhales the purified air through the mouth.) The user can select the first usage mode or the second usage mode as desired. An air quality detection element may be provided to generate a prompt signal for the user to switch the usage modes.

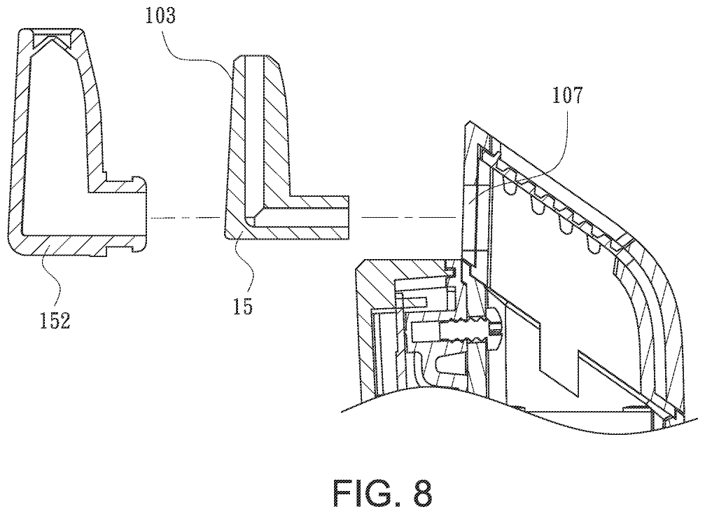

Referring to FIG. 8, because the nozzle portion (103) may be contaminated with saliva and other substances when in use, in this embodiment, the nozzle portion (103) is detachable to facilitate the removal of the nozzle portion (103) for cleaning or replacement. Part or full of the nozzle portion (103) may be made of a soft material (such as silicone). In this embodiment, the nozzle housing (15) is made of a hard material. The nozzle housing (15) is covered with a protective layer (152) made of a soft material for the nozzle portion (103) to be tightly connected to the nozzle mounting hole (107). Therefore, the user needs to exert a force sufficient to deform the protective layer (152), so as to remove the nozzle portion (103). This can prevent the nozzle portion (103) from falling off easily due to external forces, such as slight collisions.

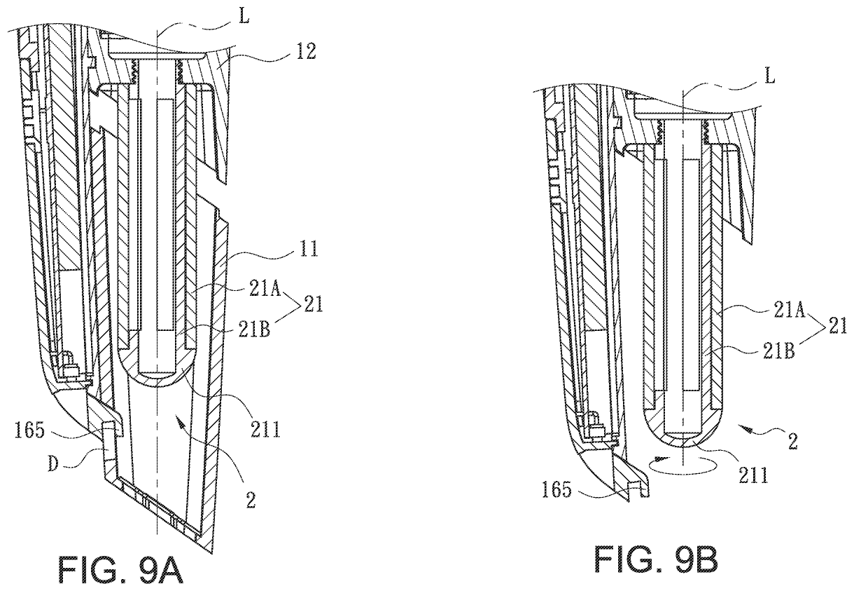

Referring to FIG. 9A and FIG. 9B, when the air purification module (2) needs to be maintained (for example, the filter body (21A) or the filter element (21) needs to be replaced), the first housing (11) is first removed. Specifically, the first housing (11) has an axial assembly gap (D) extending along the axis (L) and corresponding in position to the engaging part (165). Therefore, the first housing (11) can be pushed away from the second housing (12) along the axis (L) to release the engaging part, so as to remove the first housing (11). Preferably, the user can rotate the filter element (21) out of the retaining seat (21B) through the guide end (211), so as to replace the filter body (21A) or replace it with a new filter element (21), thereby preventing the filter body (21A) from being damaged or contaminated due to the contact of the user's fingers.

When the first housing (11) is to be assembled, the axial assembly gap (D) of the first housing (11) is first aligned with the engaging part (165), and then the first housing (11) is pushed toward the second housing (12) along the axis (L). In this way, the first housing (11) and the second housing (12) are assembled and engaged with each other through the engaging part (165).

Through the above-mentioned embodiments, the following effects can be achieved:

1. The housing (1) of the air purifier has the first air supply port (102) and the protruding nozzle portion (103). It is convenient for the user to choose different air supply modes (usage modes) as desired, so as to meet the needs of the user in different situations. Compared with the high airtightness of face masks, the portable air purifier provided by the present invention takes into account the requirements of comfort and purifying air.

2. The second air supply port (104) of the nozzle portion (103) is relatively smaller than the first air supply port (102) to concentrate the purified air for the user to inhale the purified air through the mouth conveniently. The first air supply port (102) enables the purified air to spread from the first air supply port (102) to the user's surrounding.

3. The nozzle portion (103) is detachable to facilitate the removal of the nozzle portion (103) for cleaning or replacement.

4. The air supply modes can be switched by the switching module (3) so that the purified air can be directed to the first air supply port (102) or the second air supply port (104) only, so as to reduce the dispersion of the airflow.

5. With the cylindrical filter element (21) and the diversion design, the air inflow and the filter area can be increased, and the service life of the filter element (21) can be prolonged.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A portable air purifier, comprising:
an air purification module, the air purification module including a filter element, the filter element including a filter body and a retaining seat, the filter body being a cylindrical body having two open ends, the filter body having a plurality of filter parts arranged annularly, the retaining seat being hollow and having a guide end and an outlet end opposite to the guide end, the retaining seat having a plurality of grooves arranged annularly between the guide end and the outlet end, the retaining seat being inserted in the filter body, the grooves corresponding to the filter parts, respectively;
a housing, configured to accommodate the air purification module, the filter element being disposed in an airflow passage of the housing, the retaining seat being connected to the housing, the housing having a first air supply port and a nozzle portion, the nozzle portion having a second air supply port; and
a switching module, connected to the housing and configured to guide air purified by the air purification module to the first air supply port or the second air supply port, wherein air is guided to the filter parts for filtering by the guide end and then flows through the outlet end to the first air supply port and/or the second air supply port.

2. The portable air purifier of claim 1, wherein the switching module includes a movable cover, and the movable cover is movably disposed adjacent to the first air supply port.

3. The portable air purifier of claim 2, wherein the housing has a guide part adjacent to the first air supply port, and at least one part of the guide part is disposed outside the first air supply port for at least one part of the movable cover to be moved in the guide part to an open position for opening the first air supply port.

4. The portable air purifier of claim 3, wherein the guide part is a guide channel, the movable cover is in the form of a flexible sheet having a plurality of spaced dents thereon, and the movable cover is bendable and deformable to be received in an axial section of the guide channel.

5. The portable air purifier of claim 4, wherein the movable cover has a pull portion, and the pull portion is located at the first air supply port.

6. The portable air purifier of claim 1, wherein the air purification module further includes a fan, the fan is disposed in the airflow passage of the housing.

7. The portable air purifier of claim 1, wherein the housing includes a first housing and a second housing, the first housing is detachably connected in series to the second housing; the filter body is located in the first housing, and the retaining seat is installed in the second housing.

8. The portable air purifier of claim 7, wherein the outlet end of the retaining seat and the second housing have corresponding screw threads for the outlet end of the retaining seat to be locked to the second housing, the guide end of the retaining seat extends out of the filter element, the retaining seat and the filter element are detachable from the second housing by rotating the guide end.

9. The portable air purifier of claim 1, wherein the nozzle portion is detachable.

10. The portable air purifier of claim 1, wherein the nozzle portion includes a protective layer made of a soft material and a nozzle housing made of a hard material, the nozzle housing is covered with the protective layer, through the protective layer, the nozzle portion is tightly connected to a nozzle mounting hole of the housing.

11. The portable air purifier of claim 10, wherein the housing defines an air inlet, an airflow passage and the first air supply port that communicate with each other along an axis, the second air supply port of the nozzle housing is deviated from the axis.

12. The portable air purifier of claim 1, wherein the nozzle portion is provided with a backflow preventer corresponding in position to the second air supply port.

13. The portable air purifier of claim 12, wherein the backflow preventer is in the form of a check valve.

14. The portable air purifier of claim 1, wherein the first air supply port is located adjacent to a first side of the housing, the second air supply port is located adjacent to a second side of the housing, the first air supply port is inclined toward the first side of the housing, the housing has an air inlet at another end opposite to the first air supply port, and the air inlet is inclined toward the second side of the housing.

15. The portable air purifier of claim 1, wherein the second air supply port is adjacent to the first air supply port, and the nozzle portion extending upwardly beyond the first air supply port.

16. The portable air purifier of claim 1, wherein the second air supply port is relatively smaller than the first air supply port.
